(19) United States
(12) Patent Application Publication
(10) Pub. No.: US 2025/0045315 A1
(43) Pub. Date: Feb. 6, 2025

(54) INFORMATION PROCESSING DEVICE, INFORMATION PROCESSING SYSTEM, INFORMATION PROCESSING METHOD, AND STORAGE MEDIUM

(71) Applicant: NEC Corporation, Minato-ku, Tokyo (JP)

(72) Inventor: Daisuke GOTOU, Tokyo (JP)

(73) Assignee: NEC Corporation, Minato-ku, Tokyo (JP)

(21) Appl. No.: 18/718,859

(22) PCT Filed: Dec. 23, 2021
(86) PCT No.: PCT/JP2021/047940

§ 371 Date: Jun. 12, 2024

(51) Int. Cl. G06F 16/33; G06F 16/338

(52) U.S. Cl. CPC G06F 16/3344; G06F 16/338

(57) ABSTRACT

In order to solve the problem of accurately modifying a query from a user and improving accuracy of a response, an information processing apparatus (1) includes: an input acquisition section (11) that acquires a first character string indicating a query from a user; a generation section (12) that refers to a term database and generates a second character string which is obtained by replacing at least part of the first character string with a term from the term database; an evaluation acquisition section (13) that acquires evaluation information which indicates an evaluation by the user with respect to a query result in response to a query indicated by the first character string or by the second character string; and an update section (14) that updates the term database on the basis of the evaluation information.

### TECHNICAL FIELD

The present invention relates to techniques for responding to a query from a user.

### BACKGROUND ART

Techniques for responding to a query from a user are known. For example, Patent Literature 1 discloses an information processing server that searches text data on the basis of a query from a user. On the basis of a term which is extracted from text data that is the result of the search, the information processing server modifies a character string which is included in the query and which should be modified. The information processing server also outputs the result of re-searching the text data using the result of modification.

### CITATION LIST

### Patent Literature

### [Patent Literature 1]

Japanese Patent Application Publication Tokukai No. 2018-190030

### SUMMARY OF INVENTION

### Technical Problem

The information processing server disclosed in Patent Literature 1 extracts, from text data retrieved on the basis of a query from the user, a term to be used for modifying a character string which is to be modified and which is included in the query. As such, depending on the character string which is to be modified, there is the possibility that the text data obtained as the search result may not be suitable or may not be sufficient. Therefore, there is the possibility that the information processing server may not be able to accurately extract a term to be used for modification. As such, there is the possibility that the information processing server may not be able to accurately modify a character string to be modified, and thus there is room for improving the accuracy of results of a second search.

An example aspect of the present invention was made in view of the above-described problem. An example aspect of the present invention provides techniques for accurately modifying a query from a user and improving the accuracy of a response.

### Solution to Problem

An information processing apparatus in accordance with an example aspect of the present invention includes: an input acquisition means that acquires a first character string indicating a query from a user; a generation means that refers to a term database and generates a second character string which is obtained by replacing at least part of the first character string with a term from the term database; an evaluation acquisition means that acquires evaluation information which indicates an evaluation by the user with respect to a query result in response to a query indicated by the first character string or by the second character string; and an update means that updates the term database on the basis of the evaluation information.

An information processing system in accordance with an example aspect of the present invention includes: an input acquisition means that acquires a first character string indicating a query from a user; a generation means that refers to a term database and generates a second character string which is obtained by replacing at least part of the first character string with a term from the term database; an evaluation acquisition means that acquires evaluation information which indicates an evaluation by the user with respect to a query result in response to a query indicated by the first character string or by the second character string; and an update means that updates the term database on the basis of the evaluation information.

An information processing method in accordance with an example aspect of the present invention includes: acquiring a first character string indicating a query from a user; referring to a term database and generating a second character string which is obtained by replacing at least part of the first character string with a term from the term database; acquiring evaluation information which indicates an evaluation by the user with respect to a query result in response to a query indicated by the first character string or by the second character string; and updating the term database on the basis of the evaluation information.

A program in accordance with an example aspect of the present invention is for causing a computer to function as an information processing apparatus, the program causing the computer to function as: an input acquisition means that acquires a first character string indicating a query from a user; a generation means that refers to a term database and generates a second character string which is obtained by replacing at least part of the first character string with a term from the term database; an evaluation acquisition means that acquires evaluation information which indicates an evaluation by the user with respect to a query result in response to a query indicated by the first character string or by the second character string; and an update means that updates the term database on the basis of the evaluation information.

### Advantageous Effects of Invention

According to an example aspect of the present invention, it is possible to accurately modify a query from a user and improve the accuracy of a response.

### BRIEF DESCRIPTION OF DRAWINGS

FIG. 1 is a block diagram illustrating a configuration of an information processing apparatus in accordance with a first example embodiment of the present invention.

FIG. 2 is a flowchart illustrating a flow of an information processing method in accordance with the first example embodiment of the present invention.

FIG. 3 is a block diagram illustrating a configuration of an information processing system in accordance with another aspect of the first example embodiment of the present invention.

FIG. 4 is a block diagram illustrating a configuration of an information processing system in accordance with a second example embodiment of the present invention.

FIG. 5 is a diagram illustrating a specific example of a text database in accordance with the second example embodiment of the present invention.

FIG. 6 is a diagram illustrating a specific example of a synonym database in accordance with the second example embodiment of the present invention.

FIG. 7 is a diagram illustrating a specific example of a term database in accordance with the second example embodiment of the present invention.

FIG. 8 is a flowchart illustrating a flow of an information processing method in accordance with the second example embodiment of the present invention.

FIG. 9 is a diagram illustrating a specific example of an evaluation information database in accordance with the second example embodiment of the present invention.

FIG. 10 is a flowchart illustrating a flow of a generation process in accordance with the second example embodiment of the present invention.

FIG. 11 is a flowchart illustrating a flow of an update process in accordance with the second example embodiment of the present invention.

FIG. 12 is a diagram illustrating specific examples of an evaluation score in accordance with the second example embodiment of the present invention.

FIG. 13 is a diagram for illustrating a specific example of input conversion in accordance with a third example embodiment of the present invention.

FIG. 14 is a block diagram illustrating a configuration of an information processing system in accordance with the third example embodiment of the present invention.

FIG. 15 is a diagram illustrating a specific example of a term database in accordance with the third example embodiment of the present invention.

FIG. 16 is a flowchart illustrating a flow of a generation process in accordance with the third example embodiment of the present invention.

FIG. 17 is a diagram illustrating a specific example of a generation process in accordance with the third example embodiment of the present invention.

FIG. 18 is a diagram illustrating a specific example of an evaluation information database in accordance with the third example embodiment of the present invention.

FIG. 19 is a diagram illustrating a specific example of an update process in accordance with the third example embodiment of the present invention.

FIG. 20 is a block diagram illustrating an example of a physical configuration of each of the information processing apparatuses in accordance with the example embodiments of the present invention.

### EXAMPLE EMBODIMENTS

### First Example Embodiment

The following description will discuss a first example embodiment of the present invention in detail with reference to the drawings. The present example embodiment is a basic form of example embodiments described later.

### <Configuration of Information Processing Apparatus 1>

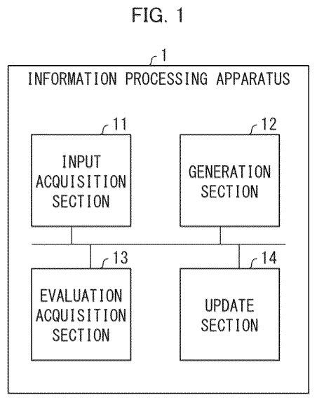

The following description will discuss a configuration of an information processing apparatus 1 in accordance with the present example embodiment with reference to FIG. 1. FIG. 1 is a block diagram illustrating a configuration of the information processing apparatus 1. The information processing apparatus 1 includes an input acquisition section 11, a generation section 12, an evaluation acquisition section 13, and an update section 14 as illustrated in FIG. 1. The input acquisition section 11 is an example of a configuration that achieves an input acquisition means recited in the claims. The generation section 12 is an example of a configuration that achieves a generation means recited in the claims. The evaluation acquisition section 13 is an example of a configuration that achieves an evaluation acquisition means recited in the claims. The update section 14 is an example of a configuration that achieves an update means recited in the claims.

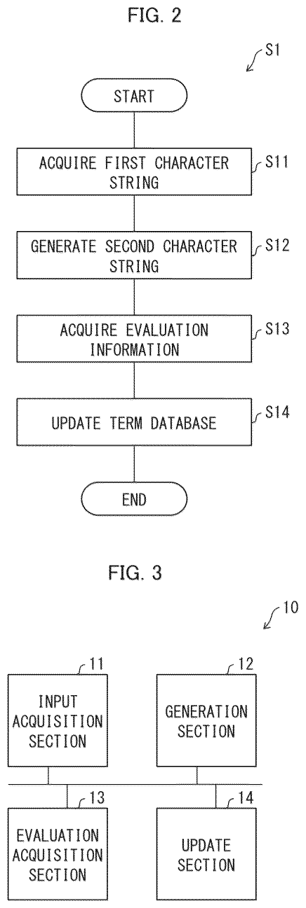

The input acquisition section 11 acquires a first character string indicating a query from a user. The generation section 12 refers to a term database and generates a second character string which is obtained by replacing at least part of the first character string with a term from the term database. The evaluation acquisition section 13 acquires evaluation information which indicates an evaluation by the user with respect to a query result in response to a query indicated by the first character string or by the second character string. The update section 14 updates the term database on the basis of the evaluation information. Details of the first character string, the second character string, the term database, and the evaluation information are described in “Flow of information processing method S1” below, with reference to FIG. 2.

### <Flow of Information Processing Method S1>

The information processing apparatus 1 configured as described above carries out an information processing method S1 in accordance with the present example embodiment. The following description will discuss a flow of the information processing method S1 with reference to FIG. 2. FIG. 2 is a flowchart illustrating a flow of the information processing method S1. The information processing method S1 includes steps S11 to S14, as illustrated in FIG. 2.

### (Step S11)

In step S11, the input acquisition section 11 acquires the first character string indicating the query from the user. The user is a user who uses a response function which returns a query result in response to the query. The information processing apparatus 1 may have such a response function, or may operate in cooperation with a response apparatus having such a response function.

The user inputs the first character string with use of an input apparatus, for example. The input apparatus used by the user may be, for example, a keyboard, a mouse, a tablet, a touch panel, a touch pad, a microphone, or a combination of these, but is not limited to these examples. Furthermore, the input apparatus may be connected to or included in the information processing apparatus 1. The input apparatus may be connected to or included in the response apparatus. Further, the input apparatus may be connected to or included in a terminal that is communicably connected to the information processing apparatus 1 or to the response apparatus.

### (Step S12)

In step S12, the generation section 12 refers to the term database and generates the second character string which is obtained by replacing at least part of the first character string with a term from the term database. The number of terms in the term database may be one or more.

### (Step S13)

In step S13, the evaluation acquisition section 13 acquires the evaluation information which indicates an evaluation by the user with respect to a query result in response to a query indicated by the first character string or by the second character string. The “query result in response to a query indicated by the first character string or by the second character string” refers to a query result that is output as a response by the response function when an query indicated by the first character string or by the second character string is input. Hereinafter, the “query result in response to a query indicated by the first character string or by the second character string” may also be referred to simply as a “query result in response to the first character string or by the second character string”.

For example, when a query result in response to the first character string is output, the evaluation acquisition section 13 acquires evaluation information with respect to that query result. Also, for example, when a query result in response to the second character string is output, the evaluation acquisition section 13 acquires evaluation information with respect to that query result.

The evaluation information indicates, for example, a good evaluation or a bad evaluation. Note, however, that the evaluation information is not limited to two levels. The evaluation information may indicate an evaluation of three or more levels.

The query result is outputted to an output apparatus. The output apparatus may be, for example, a display, a speaker, or a combination of these, but is not limited to these examples. Furthermore, the output apparatus may be connected to or included in the information processing apparatus 1. The output apparatus may be connected to or included in the response apparatus. Further, the output apparatus may be connected to or included in a terminal that is communicably connected to the information processing apparatus 1 or to the response apparatus. The user inputs the evaluation information with use of the input apparatus, for example. Specific examples of the input apparatus used by the user are as described in the explanation of step S11.

### (Step S14)

In step S14, the update section 14 updates the term database on the basis of the evaluation information. For example, in a case where the evaluation information with respect to the query result in response to the first character string indicates a good evaluation, the update section 14 may save, to the term database, a term included in the first character string. Furthermore, for example, in a case where (i) the evaluation information with respect to the query result in response to the first character string indicates a bad evaluation and (ii) a term included in the first character string is already saved to the term database, the update section 14 may delete said term. Also, for example, in a case where the evaluation information with respect to the query result in response to the first character string indicates a bad evaluation, the update section 14 may save, to the term database, a term included in the first character string. In such a case, an administrator may set, from among terms saved to the term database, which terms are to be used in step S12, based on the type of evaluation information (for example, whether or not to use a term based on a bad evaluation). Note that in this step, a specific example of a case where the term database is updated on the basis of evaluation information with respect to a query result in response to the second character string can be described in the same manner as above by replacing “first character string” with “second character string”.

### Example Advantages of Present Example Embodiment

As described above, the information processing apparatus 1 and the information processing method S1 in accordance with the present example embodiment employ a configuration in which (i) the first character string indicating the query from the user is acquired, (ii) the term database is referred to, and a second character string, which is obtained by replacing at least part of the first character string with a term from the term database, is generated, (iii) evaluation information which indicates an evaluation by the user with respect to a query result in response to a query indicated by the first character string or by the second character string is obtained, and (iv) the term database is updated on the basis of the evaluation information.

Thus, in the present example embodiment, the term database, which is used for replacing at least part of the query from the user, is updated on the basis of the evaluation by the user with respect to the query result. Using a term database updated in this way makes it possible to more accurately modify a query from a user. As a result, the present example embodiment makes it possible to accurately modify a query from a user and increase the accuracy of a response thereto.

### Another Aspect of the Present Example Embodiment

The following description will discuss another aspect of the present example embodiment, with reference to FIG. 3. FIG. 3 is a block diagram illustrating a configuration of an information processing system 10 in accordance with another aspect. The information processing system 10 includes an input acquisition section 11, a generation section 12, an evaluation acquisition section 13, and an update section 14, as illustrated in FIG. 3. The information processing system 10 includes a plurality of physically different apparatuses. The sections illustrated in FIG. 3 are provided in a distributed manner to these plurality of apparatuses. The details of the configurations and operations of each section is as described above. Thus, the information processing system 10 brings about example advantages similar to those of the information processing apparatus 1.

### Second Example Embodiment

The following description will discuss a second example embodiment of the present invention in detail with reference to the drawings. Note that elements having functions identical to those of the respective elements described in the first example embodiment are given respective identical reference numerals, and a description of those elements is omitted as appropriate.

### <Configuration of Information Processing System 10A>

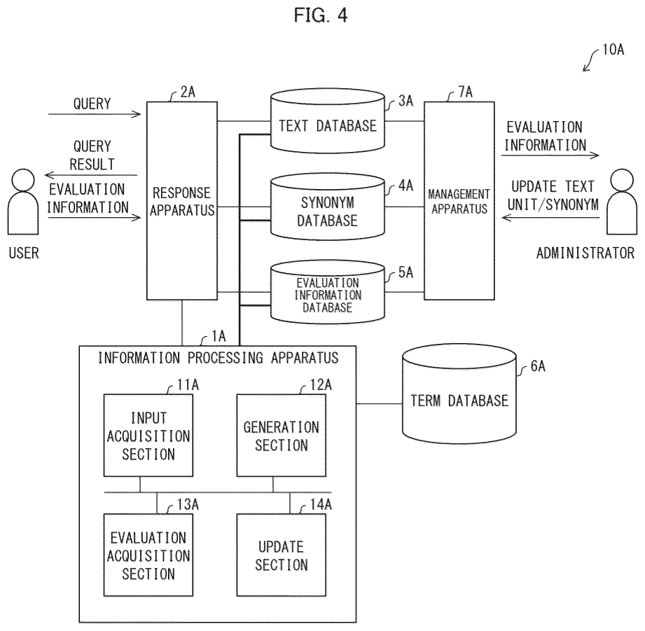

The following description will discuss a configuration of an information processing system 10A in accordance with the present example embodiment, with reference to FIG. 4. FIG. 4 is a block diagram illustrating a configuration of the information processing system 10A. The information processing system 10A includes an information processing apparatus 1A, a response apparatus 2A, a text database 3A, a synonym database 4A, an evaluation information database 5A, a term database 6A, and a management apparatus 7A, as illustrated in FIG. 4.

### (Information Processing Apparatus 1A)

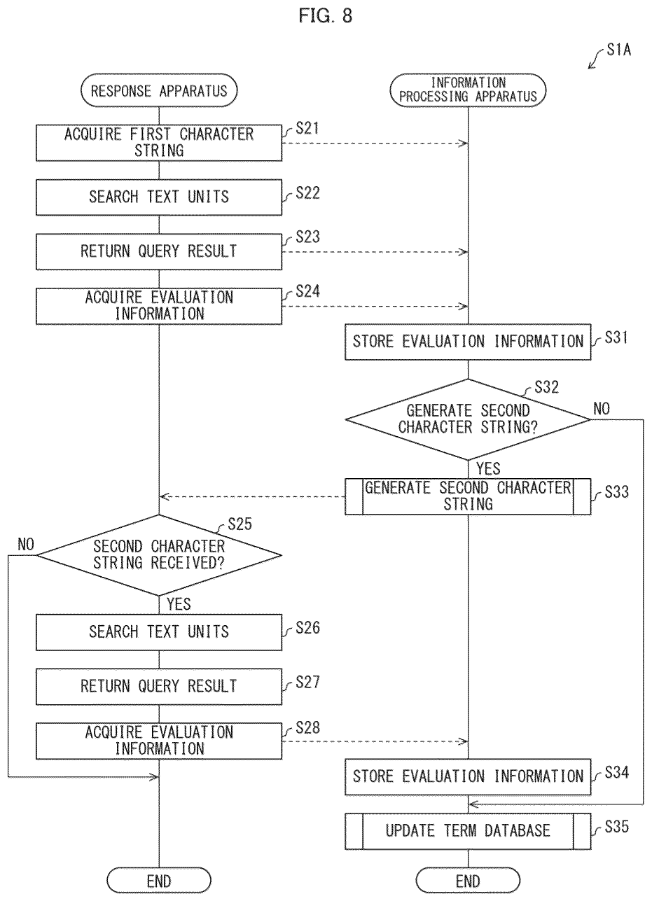

The information processing apparatus 1A is an apparatus for modifying a query input into the response apparatus 2A by a user. The information processing apparatus 1A includes an input acquisition section 11A, a generation section 12A, an evaluation acquisition section 13A, and an update section 14A, as illustrated in FIG. 4. Details of each functional block are described in “Flow of information processing method S1A” below, with reference to FIG. 8.

### (Response Apparatus 2A)

The response apparatus 2A is an apparatus that returns a query result relating to a specific field, in accordance with the query from the user. Specifically, the response apparatus 2A returns a search result as the query result, said search result being obtained by performing a search with respect to the text database 3A with use of the first character string or the second character string. The text database 3A includes a plurality of text units relating to a specific field. This will described later in detail. In other words, the query result indicates a search result obtained by using the first character string or the second character string to perform a search with respect to a plurality of text units relating to a specific field.

The response apparatus 2A also acquires evaluation information from the user with respect to the query result. Furthermore, the response apparatus 2A modifies the query from the user with use of the information processing apparatus 1A, and outputs a query result in response to the result of modification. The response apparatus 2A may be, for example, an apparatus called a chat bot, an auto-response, or the like, but is not limited to these examples. Details of the response apparatus 2A are described in “Flow of information processing method S1A” below, with reference to FIG. 8.

### (Text Database 3A)

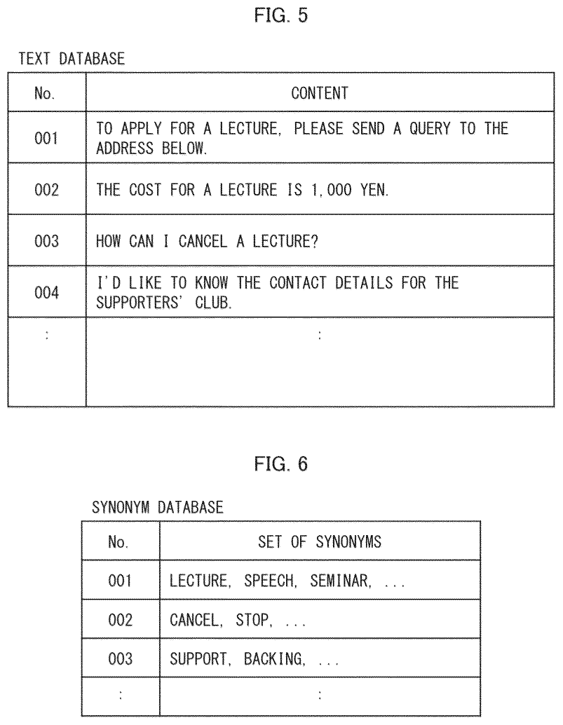

The text database 3A is a database including a plurality of text units relating to a specific field. For example, each text unit includes a question and/or an answer thereto. The text database 3A is subject to searching by the response apparatus 2A. A specific example of the text database 3A will be described with reference to FIG. 5. FIG. 5 is a diagram illustrating a specific example of the text database 3A. As illustrated in FIG. 5, The text database 3A includes text units of No. 001, 002, 003, 004, . . . , which relate to the specific field “Academic Conference on XYZ”. The text units of No. 001 and 002 represent answers. The text units of No. 003 and 004 represent questions. Text units representing questions and text units representing answers may be associated with each other.

### (Synonym Database 4A)

The synonym database 4A includes a set of synonyms relating to the specific field. A specific example of the synonym database 4A will be described with reference to FIG. 6. FIG. 6 is a diagram illustrating a specific example of the synonym database 4A. As illustrated in FIG. 6, the synonym database 4A includes a set of synonyms relating to the specific field “Academic Conference on XYZ”. Specifically, the set of No. 001, for example, indicates that “lecture”, “speech”, and “seminar” are synonyms of each other. The sets of No. 002 to No. 004 similarly indicate that the terms shown in the diagram are synonyms of each other. FIG. 6 illustrates an example where one set of synonyms includes two or three terms, but the number of terms in one set may be four our more.

### (Evaluation Information Database 5A)

The evaluation information database 5A includes evaluation information. The evaluation information indicates an evaluation by a user with respect to a query result by the response apparatus 2A. A specific example of the evaluation information is described in “Flow of information processing method S1A” below, with reference to FIG. 8.

### (Term Database 6A)

The term database 6A includes a plurality of terms and a priority of each term. The term database 6A includes some or all from among (i) terms included in a plurality of text units relating to the specific field, (ii) a set of synonyms relating to the specific field, and (iii) a term included in the first character string or the second character string.

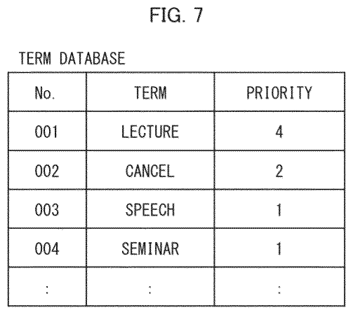

A specific example of the term database 6A will be described with reference to FIG. 7. FIG. 7 is a diagram illustrating a specific example of the term database 6A. In the example illustrated in FIG. 7, the term “lecture” of No. 001 is associated with a priority of “4”. The terms of No. 002 to No. 004 are each similarly associated with a priority. Details of the priority are described in “Flow of information processing method S1A” below, with reference to FIG. 8.

### (Management Apparatus 7A)

The management apparatus 7A is an apparatus used by an administrator who manages the information processing system 10A. The management apparatus 7A presents information saved on the evaluation information database 5A to the administrator. In the evaluation information database 5A, the first character string or the second character string is saved in association with the evaluation information. This will be described later in detail. The administrator refers to the presented information and inputs information that instructs updating of the text database 3A and/or the synonym database 4A. The management apparatus 7A updates the text database 3A and/or the synonym database 4A on the basis of input by the administrator. For example, the administrator may refer to a term included in the first character string or the second character string and add a set of synonyms to the synonym database 4A. The administrator may also refer to a term included in the first character string or the second character string and modify an existing set of synonyms. The administrator may also, for example, add to the text database 3A a query indicated by the first character string or the second character string, and a text unit indicating an answer thereto. The administrator may also, for example, refer to the query indicated by the first character string or the second character string and modify a text unit included in the text database 3A.

The presentation to the administrator is achieved, for example, by output to an output apparatus. The output apparatus may be, for example, a display, a speaker, or a combination of these, but is not limited to these examples. The output apparatus may be connected to or included in the management apparatus 7A. Further, the output apparatus may be connected to or included in a terminal that is communicably connected to the management apparatus 7A. For example, the administrator inputs information indicating the instruction into the management apparatus 7A with use of an input apparatus. The input apparatus may be, for example, a keyboard, a mouse, a tablet, a touch panel, a touch pad, a microphone, or a combination of these, but is not limited to these examples. The input apparatus may be connected to or included in the management apparatus 7A. Further, the input apparatus may be connected to or included in a terminal that is communicably connected to the management apparatus 7A.

Updating of the text database 3A and the synonym database 4A by the management apparatus 7A may be performed at an arbitrary timing.

### <Flow of Information Processing Method S1A>

The information processing system 10A configured as described above performs an information processing method S1A in accordance with the present example embodiment. The following description will discuss the flow of the information processing method S1A with reference to FIG. 8. FIG. 8 is a flowchart illustrating a flow of the information processing method S1A. As illustrated in FIG. 8, the information processing method S1A includes steps S21 to S28, which are performed by the response apparatus 2A, and steps S31 to S35, which are performed by the information processing apparatus 1A.

### (Step S21)

In step S21, the response apparatus 2A acquires the first character string which was input by the user and which indicates the query from the user, and sends the first character string thus acquired to the information processing apparatus 1A. Thus, the input acquisition section 11A of the information processing apparatus 1A acquires the first character string. As a specific example, the first character string that has been acquired may be, for example, “I'd like to know the cost for a speech.” An input apparatus which is used by the user to input the first character string is as described in the first example embodiment.

### (Step S22)

In step S22, the response apparatus 2A searches a plurality of text units included in the text database 3A with use of the first character string. In the example illustrated in FIG. 5, there is no text unit that relates to the first character string “I'd like to know the cost for a speech” and that is saved in the text database 3A. Therefore, in this case, the search result has zero hits (the number of text units included in the search results is zero).

### (Step S23)

In step S23, the response apparatus 2A returns the search result in step S22 as the query result. For example, the response apparatus 2A outputs, to an output apparatus, the query result and information requesting input of evaluation information with respect to the query result.

For example, the response apparatus 2A may display, on a display, the query result and a user interface component for selecting “Like” or “Dislike”. The response apparatus 2A sends the query result also to the information processing apparatus 1A.

### (Step S24)

In step S24, the response apparatus 2A acquires evaluation information with respect to the query result returned in step S23, and sends the evaluation information that has been acquired to the information processing apparatus 1A. Note, however, that input of the evaluation information by the user is voluntary. In other words, there are cases where the response apparatus 2A can acquire the evaluation information, and cases where the response apparatus 2A cannot acquire the evaluation information. In a case where input of the evaluation information from the user could not be obtained, the response apparatus 2A sends, to the information processing apparatus 1A, information indicating that the evaluation information could not be obtained. Hereinafter, the “information indicating that the evaluation information could not be obtained” may also be referred to as evaluation information indicating “no evaluation”. Thus, the evaluation acquisition section 13A of the information processing apparatus 1A acquires evaluation information with respect to a query result in response to the first character string. An input apparatus which is used by the user to input the evaluation information is as described in the first example embodiment.

### (Step S31)

In step S31 the evaluation acquisition section 13A of the information processing apparatus 1A associates the evaluation information that has been acquired, with the first character string that was acquired by the input acquisition section 11A, and saves the evaluation information and the first character string in the evaluation information database 5A. This step may be performed by the response apparatus 2A.

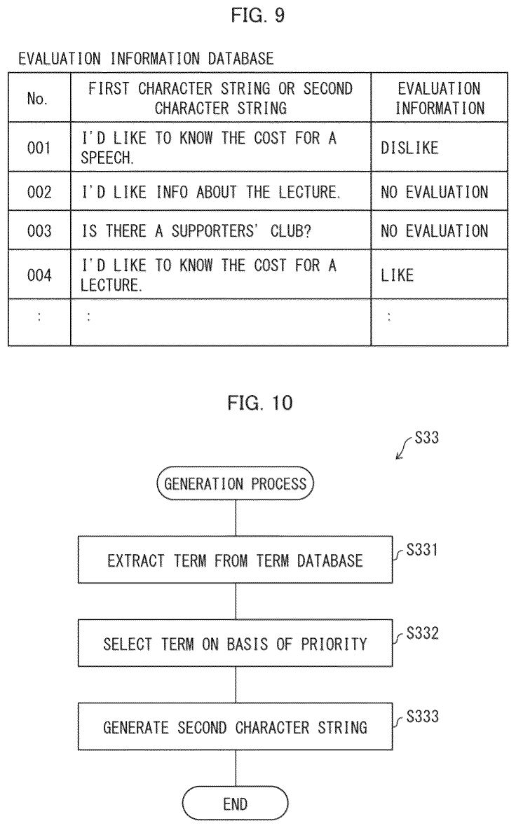

A specific example of the evaluation information database 5A will be described here with reference to FIG. 9. FIG. 9 is a diagram illustrating a specific example of the evaluation information database 5A. In the example illustrated in FIG. 9, the evaluation information “Dislike” of No. 001, is associated with the first character string, “I'd like to know the cost for a speech”. This indicates that the user gave a poor evaluation to the query result (search result of zero hits) in response to the first character string, “I'd like to know the cost for a speech”.

Furthermore, the evaluation information “No evaluation” of No. 002 in FIG. 9 is associated with the first character string “I'd like info about the lecture”. Further, the evaluation information “No evaluation” of No. 003 in FIG. 9 is associated with the first character string “Is there a supporters' club?” These indicate that the user did not input evaluation information into the response apparatus 2A with respect to the query results in response to these first character strings. The evaluation information of No. 004 will be described later in step S28.

### (Step S32)

In step S32, the generation section 12A of the information processing apparatus 1A determines whether or not to generate a second character string. For example, in a case where the amount of information included in a query result in response to the query indicated by the first character string is less than or equal to a threshold value, the generation section 12A may determine that a second character string is to be generated. The amount of information included in the query result is, for example, the number of text units included in the query result. The threshold value may be zero, for example, but is not limited to this. Furthermore, for example, in a case where the evaluation information with respect to the query result in response to the query result indicated by the first character string satisfies a predetermined condition, the generation section 12A may determine that a second character string is to be generated. The evaluation information satisfying a predetermined condition may be, for example, the evaluation information being “Dislike”, or a state where the evaluation information is not obtained, but these examples are non-limiting. This step may be performed by the response apparatus 2A. In such a case, the information processing apparatus 1A receives a determination result from the response apparatus 2A.

### (Step S33)

In step S33, the generation section 12A refers to the term database 6A and generates the second character string which is obtained by replacing at least part of the first character string with a term from the term database 6A. The generation section 12A sends the second character string to the response apparatus 2A. Assumed here is a case where the second character string, “I'd like to know the cost for a lecture”, has been generated from the first character string, “I'd like to know the cost for a speech”. Details of the process of this step are described later with reference to a different figure.

### (Step S25)

In step S25, the response apparatus 2A determines whether or not a second character string has been received from the information processing apparatus 1A. In a case where the determination is “No” in step S25, the operation of the response apparatus 2A ends. In a case where the determination is “Yes” in step S25, the response apparatus 2A performs the process of step S26.

### (Step S26)

In step S26, the response apparatus 2A searches the plurality of text units included in the text database 3A with use of the second character string. In the example illustrated in FIG. 5, the text unit of No. 002, which relates to the second character string “I'd like to know the cost for a lecture”, is saved in the text database 3A. Therefore, in this case, the text unit of No. 002 is included in the search result.

### (Step S27)

In step S27, the response apparatus 2A returns the search result in step S26 as the query result. At this time, the response apparatus 2A outputs, to the output apparatus, the query result and information requesting input of evaluation information with respect to the query result. A specific example of output content is as described in step S23.

### (Step S28)

In step S28, the response apparatus 2A acquires evaluation information with respect to the query result returned in step S27, and sends the evaluation information that has been acquired to the information processing apparatus 1A. Similarly to step S24, input of the evaluation information by the user is voluntary. A specific example of input of the evaluation information is as described in step S24. In a case where input of the evaluation information from the user could not be obtained, the response apparatus 2A sends, to the information processing apparatus 1A, information indicating that the evaluation information could not be obtained (evaluation information indicating “no evaluation”). Thus, the evaluation acquisition section 13A of the information processing apparatus 1A acquires evaluation information with respect to a query result in response to the second character string.

### (Step S34)

In step S34, the evaluation acquisition section 13A of the information processing apparatus 1A associates the evaluation information that has been acquired, with the second character string that was generated by the generation section 12A, and saves the evaluation information and the second character string in the evaluation information database 5A. This step may be performed by the response apparatus 2A.

A specific example of information that is added to the evaluation information database 5A and saved is described here with reference to FIG. 9. In the example illustrated in FIG. 9, the evaluation information “Like” of No. 004 is associated with the second character string “I'd like to know the cost for a lecture”. This indicates that the user gave a good evaluation to the query result (search result of 1 hit) in response to the second character string, “I'd like to know the cost for a lecture”.

### (Step S35)

In step S35, the update section 14A refers to the evaluation information database 5A and updates the term database 6A. Details of the process of this step are described later with reference to a different figure.

### <Details of Generation Process (Step S33)>

Details of the generation process in step S33 will be described with reference to FIG. 10. FIG. 10 is a flowchart illustrating a flow of the generation process in step S33. As illustrated in FIG. 10, the generation process in step S33 includes steps S331 to S333.

### (Step S331)

In step S331, the generation section 12A extracts, from the term database 6A, a term relevant to a term included in the first character string. The number of terms that are extracted may be one, or more than one. In other words, the generation section 12A identifies, from among terms constituting the first character string, a term that is relevant to a term in the term database 6A, as a modification location. A specific example 1 and specific example 2 of a process for extracting a relevant term will be discussed here.

### Specific Example 1

For example, the generation section 12A may refer to the synonym database 4A and extract, from the term database 6A, a synonym of a term included in the first character string. For example, referring to the set of No. 001 of the synonym database 4A illustrated in FIG. 6, synonyms of the term “speech”, which is included in the first character string “I'd like to know the cost for a speech”, are the term “lecture” and the term “seminar”. Thus, the generation section 12A extracts the term “lecture” and the term “seminar” from the term database 6A. In this case, the term “speech” is the modification location in the first character string.

### Specific Example 2

Note that the term in term database 6A that is relevant to the term in the first character string is not limited to being a synonym. For example, the generation section 12A may extract a term in the term database 6A that has a similar spelling to a term included in the first character string. For example, in a case where the term “speach” is included in the first character string and the term “speech” is included in the term database 6A, the term “speach” and the term “speech” have similar spellings. Such similarity of spelling includes, for example, cases where the term included in the first character string is a misspelling of a term in the term database 6A. In this case, the generation section 12A may extract the term “speech” from the term database 6A. Known techniques may be used for a process for determining the similarity of spelling. Note that the relevance between terms is not limited to synonyms as in specific example 1, nor to similarity of spelling as in specific example 2, and may be some other relevance.

### (Step S332)

In step S332, the generation section 12A selects, on the basis of priority, one of the plurality of terms extracted from the term database 6A. Specifically, the generation section 12A may select a term having the highest priority among the plurality of terms extracted from the term database 6A. Note that in a case where only one term was extracted, the generation section 12A selects the extracted term.

### (Step S333)

In step S333, the generation section 12A replaces the term identified as the modification location in the first character string (i.e., replaces at least part of the first character string) with the term selected in step S332. Thus, the generation section 12A produces the second character string as the character string after replacement.

### <Details of Update Process (Step S35)>

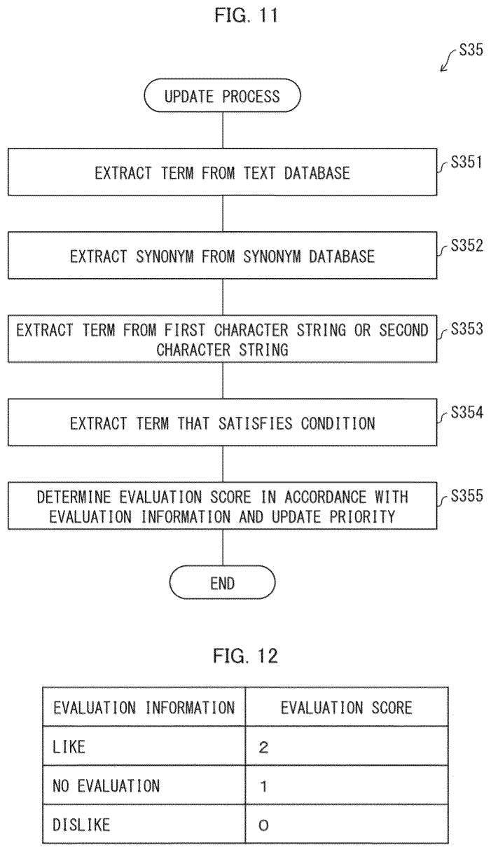

Details of the update process in step S35 will be described with reference to FIG. 11. FIG. 11 is a flowchart illustrating a flow of the update process in step S35. As illustrated in FIG. 11, the update process in step S35 includes steps S351 to S355.

### (Step S351)

In step S351, the update section 14A extracts a term from the plurality of text units included in the text database 3A. For example, in a case where the text units are expressed with a language (such as English) that includes a delimiting character (such as a space) for terms, the update section 14A extracts a term on the basis of the delimiting character. Alternatively, in a case where, for example, the text units are expressed with a language (such as Japanese) that does not include a delimiting character for terms, the update section 14A extracts a term with use of known techniques for extracting terms from sentences of such a language. As a specific example, the update section 14A extracts various terms, such as “lecture”, “apply”, “below”, and “query” from the text unit of No. 001 illustrated in FIG. 5. Among the plurality of text units included in the text database 3A, the update section 14A may extract a term from text units that indicate questions and avoid extracting terms from text units that indicate answers.

The text database 3A can be updated by the management apparatus 7A at an arbitrary timing. In a case where the text database 3A has not been updated between the last performance of the update process and the current performance thereof, the update section 14A may omit the process of step S351. Furthermore, the update section 14A may be configured to perform the process of step S351 only for a portion of the text database 3A which has been updated between the last performance of the update process and the current performance thereof.

### (Step S352)

In step S352, the update section 14A extracts a term from a set of synonyms included in the synonym database 4A. As a specific example, the update section 14A extracts the various terms “lecture”, “speech”, “seminar”, etc. from the set of synonyms of No. 001 illustrated in FIG. 6.

The synonym database 4A can be updated by the management apparatus 7A at an arbitrary timing. In a case where the synonym database 4A has not been updated between the last performance of the update process and the current performance thereof, the update section 14A may omit the process of step S352. Furthermore, the update section 14A may be configured to perform the process of step S352 only for a portion of the synonym database 4A which has been updated between the last performance of the update process and the current performance thereof.

### (Step S353)

In step S353, the update section 14A refers to the evaluation information database 5A and extracts a term from the first character string or the second character string. In the example illustrated in FIG. 9, the update section 14A extracts the various terms “speech”, “cost”, “know”, etc. from the first character string “I'd like to know the cost for a speech” of No. 001.

### (Step S354)

In step S354, the update section 14A extracts a term which satisfies a condition from among the terms extracted in steps S351 to S353. Examples of the condition include the condition of being “a verb or a noun”, etc. but the condition is not limited to this example.

### (Step S355)

In step S355, the update section 14A updates, on the basis of the evaluation information, the priority of each term extracted in step S354.

The update section 14A updates the priority of each term on the basis of the evaluation information associated with that term. It can be considered that the term extracted in step S354 is associated with evaluation information. Specifically, the term extracted from the first character string or the second character string is associated with evaluation information that is associated with the first character string or the second character string which includes that term. Furthermore, a term extracted from the text database 3A or the synonym database 4A is considered equivalent to a case where evaluation information has not been obtained. In other words, a term extracted from the text database 3A or the synonym database 4A is associated with the evaluation information “no evaluation”.

More specifically, the update section 14A gives, to each term extracted in step S354, an evaluation score that is larger to smaller for the following cases in the following order: the evaluation indicated by the evaluation information being good (Like); no evaluation being obtained; and the evaluation indicated by the evaluation information being bad (Dislike). Furthermore, the update section 14A updates the priority of each term in the term database 6A on the basis of the evaluation scores. The evaluation scores are an example of a “weight coefficient” recited in the claims. The following description will discuss the evaluation score in detail.

The evaluation information “Like” indicates an active intention of the user. In this case, presumably the response apparatus 2A was able to return a query result expected by the user. Therefore, a term associated with the evaluation information “Like” presumably has high importance as a term to be used for improving accuracy of the response. Thus, the evaluation score of the term is preferably high.

Furthermore, the evaluation information “Dislike” indicates an active intention of the user. In this case, presumably the response apparatus 2A was not able to return a query result expected by the user. In this case, there is a possibility that the query itself differs from the specific field assumed by the response apparatus 2A. For example, there is a high likelihood that it would not be possible to obtain a query result expected by the user with regard to a query about parks from the response apparatus 2A, which assumes the specific field “Academic Conference on XYZ”. Furthermore, even if the query result itself is in the specific field, there is the possibility that the query result may not be that expected by the user. For example, in a case where a query result relating to lecture tickets was provided with respect to a query relating to the date of a lecture, that query result would not be one expected by the user. Therefore, a term associated with such evaluation information presumably has low importance as a term to be used for improving accuracy of the response. Thus, the evaluation score of the term is preferably low.

Furthermore, cases where the evaluation information “no evaluation” was acquired, i.e., cases where an active intention by the user was not obtained presumable include a case in which the response apparatus 2A has returned a query result expected by the user but the user did not input an evaluation. Therefore, there are presumably cases where a term associated with the evaluation information “no evaluation” has high importance as a term to be used for improving accuracy of the response. Thus, the evaluation score of the term is preferably lower than that when the evaluation information is “Like”, but higher than that when the evaluation information is “Dislike”.

The following description will discuss specific examples of the evaluation score with reference to FIG. 12. FIG. 12 is a diagram illustrating specific examples of the evaluation score. In the example illustrated in FIG. 12, an evaluation score of 2 is determined for a case where the evaluation information is “Like”, an evaluation score of 0 is determined for “Dislike”, and an evaluation score of 1 is determined for “no evaluation”.

Furthermore, in a case where a plurality of instances of the same term have been extracted in step S354, the update section 14A may use, as the priority, a value obtained by adding the decided evaluation score for each instance of the term. Additionally, in a case where the term is already saved in the term database 6A, a value obtained by adding the evaluation scores may be used as the post-update priority, in place of the pre-update priority. In other words, the update section 14A may overwrite the pre-update priority with a value obtained by adding the evaluation scores.

As a specific example, for each instance of the term “lecture” extracted from the text units of No. 001, 002, and 003 illustrated in FIG. 5, the update section 14A determines an evaluation score of 1, considering the term to be associated with the evaluation information “no evaluation”. Furthermore, for the term “lecture” extracted from the synonym set of No. 001 illustrated in FIG. 6, the update section 14A determines an evaluation score of 1, considering the term to be associated with the evaluation information “no evaluation”. Furthermore, for the term “lecture” extracted from the first character string of No. 002 illustrated in FIG. 9, the update section 14A determines an evaluation score of 1, since the term is associated with the evaluation information “no evaluation”. Further, for the term “lecture” extracted from the second character string of No. 004 illustrated in FIG. 9, the update section 14A determines an evaluation score of 2, since the term is associated with the evaluation information “Like”. For these six instances of the term “lecture”, the update section 14A calculates 7 by adding the respective determined evaluation scores 1, 1, 1, 1, 1, and 2. The update section 14A uses the totaled evaluation score of 7 as the post-update priority and updates the term database 6A by overwriting the pre-update priority 4 of the term “lecture” of No. 001 illustrated in FIG. 7. Note that in a case where the update section 14A has calculated a priority for an un-registered term that is not saved in the term database 6A, the update section 14A adds that term to the term database 6A. However, in a case where the priority (total evaluation score) calculated for the un-registered term is zero, the update section 14A may skip addition of that term to the term database 6A.

Note that specific values of the evaluation score and the method for updating the priority on the basis of the evaluation score are not limited to the values and method described above.

### Example Advantages of Present Example Embodiment

As described above, the present example embodiment employs a configuration in which (i) the query result indicates a search result obtained by using the first character string or the second character string to search a plurality of text units that relate to the specific field and that are included in the text database 3A, and (ii) the term database 6A includes some or all of the following: terms included in the plurality of text units; a set of synonyms relating to the specific field; and a term included in the first character string or the second character string.

The terms included in the plurality of text units saved in the text database 3A are suitable for a query with respect to the text units. Furthermore, the set of synonyms relating to the specific field saved in the synonym database 4A is suitable for a query with respect to the specific field. Further, the first character string input by the user or the second character string obtained by modifying the first character string may contain a term that suitably reflects an intent of the query by the user. Furthermore, these terms are updated on the basis of evaluation information from the user, and are therefore more suitable for a query with respect to the specific field.

Therefore, according to the above configuration, the present example embodiment is able to modify a query from the user into a character string suitable for a query relating to the specific field. As a result, there is an increased likelihood that the response apparatus 2A can retrieve a suitable text unit, and it is possible to improve the accuracy of a response.

Furthermore, the present example embodiment employs a configuration in which (i) the term database 6A includes a plurality of terms and a priority of each term, (ii) the generation section 12A replaces at least part of the first character string with a term selected from the plurality of terms in the term database 6A on the basis of the priorities, and (iii) the update section 14A updates the priority of each term in the term database 6A on the basis of the evaluation information.

According to the above configuration, a suitable term selected (i) in accordance with an evaluation by the user with respect to the query result and (ii) from among terms included in the first character string input by the user or a second character string obtained by modifying the first character string is used when generating a second character string. As a result, it is possible to improve the accuracy of a response.

Furthermore, the present example embodiment employs a configuration in which the update section 14A (i) gives, to each term in the term database 6A, an evaluation score that is larger to smaller for the following cases in the following order: the evaluation indicated by the evaluation information being good; no evaluation information being obtained; and the evaluation indicated by the evaluation information being bad, and (ii) updates the priority of each term in the term database 6A on the basis of the evaluation score.

According to the above configuration, in a case where there is a good evaluation by the user with respect to a query result in response to the first character string input by the user or a second character string obtained by modifying the first character string, priority is updated with importance given to a term included in the first character string or the second character string. As a result, it is possible to generate a second character string with higher accuracy.

Furthermore, according to the above configuration, in a case where an evaluation by the user is not obtained, priority can be updated, with the importance given to a term included in the first character string or the second character string being next highest after that for a case where the evaluation is good. This is because a case where an evaluation is not obtained is not necessarily limited to a bad evaluation by the user, and may include a good evaluation. Therefore, there is the possibility that the first character string or the second character string includes a term that should be considered important.

Furthermore, according to the above configuration, in a case where there is a bad evaluation by the user, priority can be updated so that a term included in the first character string or the second character string is not considered important. This is because, in the case of a bad evaluation, there is a high likelihood that the content of the query from the user is, to begin with, not of the specific field that the response apparatus 2A is directed to, or the query result was not one that was expected by the user.

Furthermore, the present example embodiment employs a configuration in which the second character string is generated in a case where the amount of information included in a query result in response to the first character string is less than or equal to a threshold value.

In a case where the amount of information (number of text units) included in the query result in response to the first character string is less than or equal to a threshold value (for example, in a case where the search result has zero hits), presumably user satisfaction will be low. According to the above configuration, the second character string is generated in such a case. Therefore, the response apparatus 2A can return a query result again with use of the second character string that has been generated, and it is possible to improve user satisfaction.

Furthermore, in the present example embodiment, the generation section 12A may generate the second character string in a case where evaluation information with respect to a query result in response to the first character string satisfies a predetermined condition. According to the above configuration, the second character string is generated in such a case. Therefore, the response apparatus 2A can return a query result again with use of the second character string that has been generated, and it is possible to improve user satisfaction.

### Third Example Embodiment

The following description will discuss a third example embodiment of the present invention in detail with reference to the drawings. Note that elements having functions identical to those of the respective elements described in the first example embodiment are given respective identical reference numerals, and a description of those elements is omitted as appropriate. In the present example embodiment, discussed is an embodiment in which a first character string is input into a response apparatus with use of an input language that involves input conversion.

### <Input Language Involving Input Conversion>

First, the following description will discuss, in detail, a language which involves input conversion and to which the present example embodiment is applied. Examples of such input languages include “Japanese”, “Chinese”, etc. Input conversion refers to “conversion” of information that has been “input” by a user, into a type of character used in that language. Input conversion requires a variety of operations by the user. For this reason, in a case where an operation by the user during input conversion differs from an actual intent, a first character string input into the response apparatus may include an error. Even in such a case, the present example embodiment makes it possible to accurately modify the error in the first character string and improve accuracy of a response.

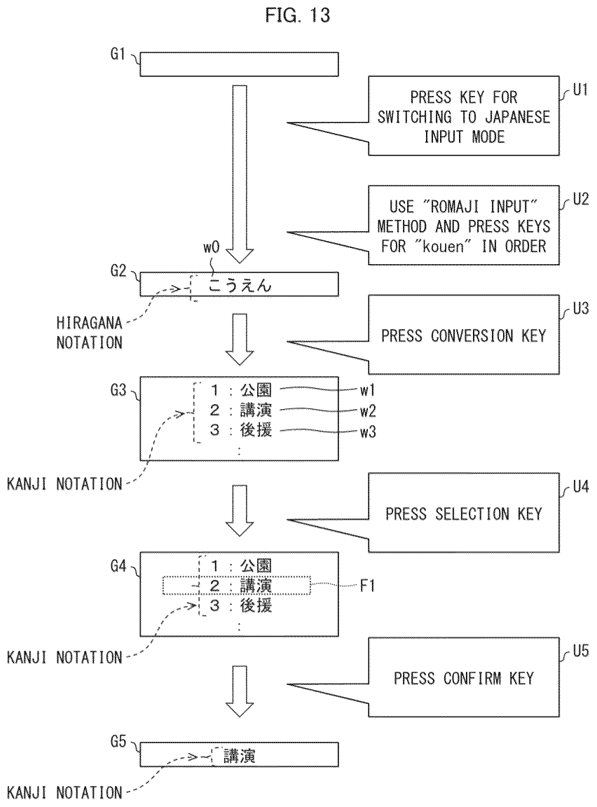

The following description will discuss a specific example of input conversion in Japanese, with reference to FIG. 13. Japanese is represented using a plurality of types of characters, such as “kanji”, “hiragana”, and “katakana”. “Kanji” are called ideographic characters, for which one character has a certain meaning. “Hiragana” and “katakana” are called phonetic characters, for which one character does not have a meaning, and which only represent sound. Therefore, Japanese phonetic readings are expressed with hiragana or katakana. Representation of Japanese phonetic readings with use of hiragana is also referred to as “hiragana notation” herein. Furthermore, representation of a Japanese term with use of kanji is also referred to as “kanji notation” herein. Also, representation of Japanese writing which includes some or all of “kanji”, “hiragana”, and “katakana” is also referred to as “Japanese notation” herein.

Furthermore, in Japanese, “romaji” (“Roman letters”) are defined, in which alphabetic strings correspond to Japanese sounds. When inputting Japanese with use of a keyboard having alphabet keys, the “romaji input method”, in which Japanese phonetic readings are input with these romaji, is often used. FIG. 13 is a diagram illustrating a specific example of input conversion in “Japanese” with use of the romaji input method.

In FIG. 13, G1 to G5 each indicate an input region of an application on a display, and U1 to U5 indicate a series of operations in the input conversion. Discussed here is an example in which a term w2 that has the meaning “lecture”, and that is in kanji notation is input.

The input region G1 indicates a display state in which characters have not yet been input in the input region. In this state, first, the user performs the operation U1. The operation U1 is an operation in which a switching key (for example, an “Esc” key) for switching to a “Japanese input mode” is pressed.

Next, the user performs the operation U2. The operation U2 is an operation in which each key for the alphabetic string “kouen” is pressed in order. The alphabetic string “kouen” is “romaji” corresponding to the phonetic reading of the Japanese term w2. Thus, display in the input region G1 changes as shown in the input region G2. In the input region G2, “hiragana notation” w0 which indicates the phonetic reading of the term w2 is displayed.

Next, the user performs the operation U3. The operation U3 is an operation in which a “conversion key” (for example, assigned to the space key) is pressed, and which converts the “phonetic reading” displayed on the screen into “kanji”, etc. Thus, display in the input region G2 changes as shown in the input region G3. Displayed in the input region G3 are a plurality of terms w1 to w3 in kanji notation. In Japanese, there are many cases in which there are a plurality of terms that correspond to the same “phonetic reading” but have different meanings. In such a case, the terms having different meanings also have different “kanji notations”. Therefore, in many cases, the operation U3 results in the display of a plurality of different terms w1 to w3 as candidates. The terms w1 to w3 all have the same phonetic reading in Japanese.

Next, the user performs the operation U4. The operation U4 is an operation in which a selection key (for example, assigned to an arrow key) is pressed as many times as necessary, and in which one of the plurality of terms w1 to w3 is selected. Thus, display in the input region G3 changes as shown in the input region G4. Displayed in the input region G4 is a figure F1 indicating that the term w2 is selected.

Next, the user performs the operation U5. The operation U5 is an operation in which a “confirm key” (for example, assigned to the enter key) is pressed, and in which the selection is confirmed. Thus, display in the input region G4 changes as shown in the input region G5. In other words, displayed in the input region G5 is the term w2, which has been confirmed as the input.

Thus, in the example of FIG. 13, the series of operations U1 to U5 is required in order to input, via input conversion, the term w2, which has the meaning “lecture” and which is in kanji notation. Examples of errors in operation that often occur in such input conversion include the following: (i) the operations operation U2 to U5 are performed without performing the operation U1, and thus the alphabetic string which represents, in romaji notation, the phonetic reading of the term to be input is input and confirmed as is; (ii) after the operation U1, the operation U5 is performed without performing operations U2 to U4, and thus the hiragana notation is input and confirmed as is; and (iii) an error is made in the selection operation in operation U4, and thus a term having the same phonetic reading but a different meaning (in other words, a homophone) is input and confirmed.

The present example embodiment improves the accuracy of a response even in a case where a query with respect to the response apparatus includes an error unique to a language involving input conversion such as that above.

### <Configuration of Information Processing System 10B>

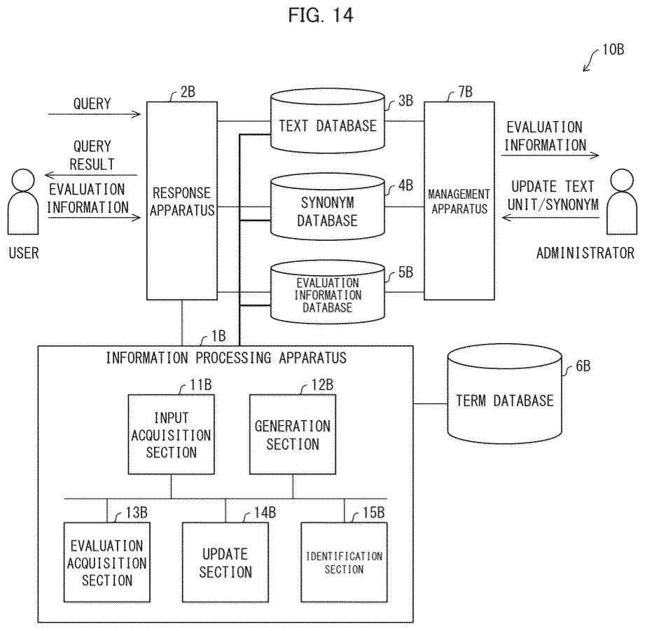

The following description will discuss a configuration of an information processing system 10B in accordance with the present example embodiment, with reference to FIG. 14. FIG. 14 is a block diagram illustrating a configuration of the information processing system 10B. The information processing system 10B includes an information processing apparatus 1B, a response apparatus 2B, a text database 3B, a synonym database 4B, an evaluation information database 5B, a term database 6B, and a management apparatus 7B, as illustrated in FIG. 14.

The response apparatus 2B, the text database 3B, the synonym database 4B, the evaluation information database 5B, and the management apparatus 7B, are configured in substantially the same manner as the apparatuses of the same name in the second example embodiment. However, the response apparatus 2B receives input of a first character string that uses a language involving input conversion, and outputs information in that language. In other words, the first character string is input by a user with use of an input language involving input conversion. The management apparatus 7B receives input via the language involving input conversion and outputs information in that language. Furthermore, information represented with the language involving input conversion is saved in the text database 3B, the synonym database 4B, and the evaluation information database 5B. Other aspects of these apparatuses are as described in the second example embodiment, and therefore a detailed description thereof is omitted here.

### (Information Processing Apparatus 1B)

The information processing apparatus 1B includes an input acquisition section 11B, a generation section 12B, an evaluation acquisition section 13B, an update section 14B, and an identification section 15B. The identification section 15B is an example of a configuration that achieves an identification means recited in the claims. The input acquisition section 11B and the evaluation acquisition section 13B are configured in substantially the same manner as the sections of the same name in the second example embodiment. Details of the generation section 12B, the update section 14B, and the identification section 15B will be described later.

### (Term Database 6B)

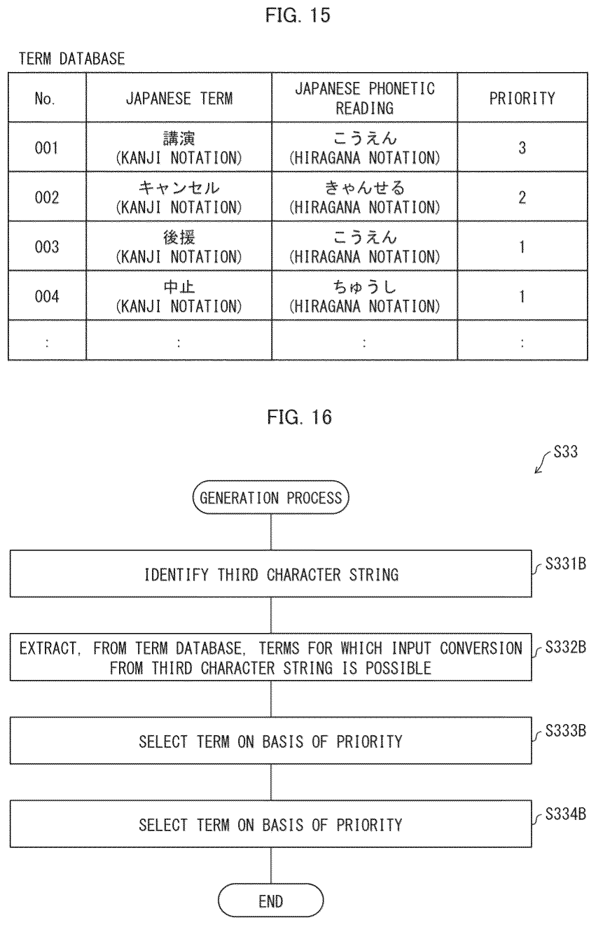

The term database 6B includes information that is substantially similar to that in the term database 6A of the second example embodiment. However, the term database 6B differs from the term database 6A in that, in the term database 6B, each term is in Japanese notation, and in addition to a priority, a “phonetic reading” is further associated with each term. A specific example of the term database 6B will be described with reference to FIG. 15. FIG. 15 is a diagram illustrating a specific example of the term database 6B. In the example illustrated in FIG. 15, the information of No. 001 is information in which the Japanese term “ [symbol] ” (“lecture”) in kanji notation, the Japanese phonetic reading thereof, and a priority are associated. The information of No. 002 to 004 can be described similarly.

### <Details of Generation Process (Step S33)>

The information processing system 10B configured as described above performs the information processing method S1A illustrated in FIG. 8 in a manner substantially similar to the information processing system 10A of the second example embodiment. However, the details of the process of step S33 differ from the process of step S33 of the second example embodiment.

Details of the process of step S33 of the present example embodiment will be described with reference to FIG. 16. FIG. 16 is a flowchart illustrating a flow of the generation process in step S33. As illustrated in FIG. 16, the process of step S33 includes steps S331B to S334B.

### (Step S331B)

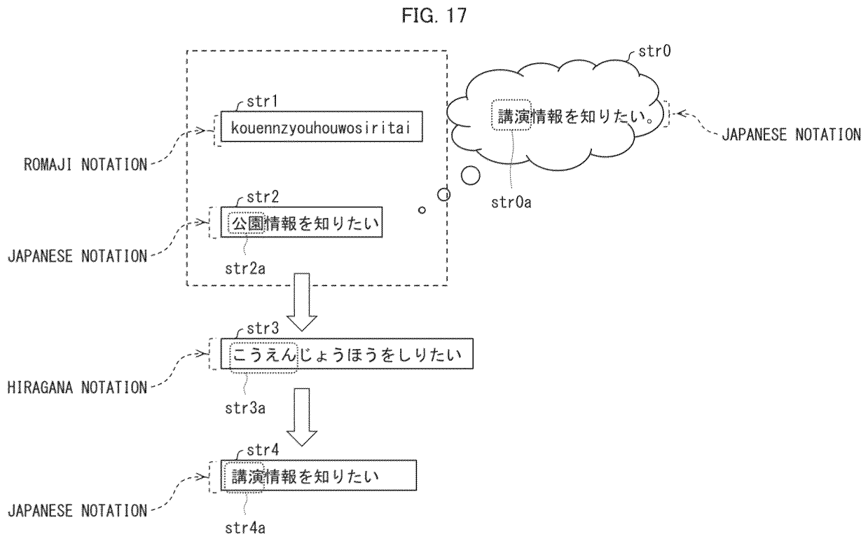

In step S3311B, the identification section 15B identifies, with respect to the first character string, a third character string that is a character string prior to input conversion. The following description will discuss identification of the third character string with reference to FIG. 17. FIG. 17 is a diagram illustrating a specific example of the generation process in step S33 of the present example embodiment.

In the example illustrated in FIG. 17, a character string str0 is a sentence in Japanese notation having the meaning “I'd like info about the lecture” and is a character string which the user actually intends to input in step S21. Assumed here is a case where there was an error in an operation for inputting the character string str0, such that a first character string str1 or a first character string str2 was input.

Specifically, the first character string str1 is obtained by inputting and confirming “romaji notation” corresponding to the phonetic reading of the character string str0 as is, as described with reference to FIG. 13. The identification section 15B interprets such a first character string str1 as being in “romaji” notation, and thereby identifies a third character string str3 in hiragana notation which is the corresponding Japanese phonetic reading.

Furthermore, the first character string str2 is obtained by selecting and confirming, in part of the character string str0, a homophone that differs from what is actually intended, as described with reference to FIG. 13. Specifically, str2a (having the meaning “park”) which is in kanji notation and is included in the character string str2, is a homophone of str0a, which is in kanji notation and is included in the character string str0. The identification section 15B identifies, with respect to the first character string str2 in Japanese notation, the third character string str3 in hiragana notation which is the corresponding “phonetic reading” of the entire sentence.

### (Step S332B)

In step S332B, the generation section 12B extracts, from the term database 6B, a term for which input conversion from at least part of the third character string is possible. Specifically, for example, the generation section 12B extracts, from the term database 6B, at least one term with which a character string included in the third character string is associated as a “phonetic reading”. Each such term can be said to be a term for which input conversion from at least part of the third character string is possible. For example, str3a, which is part of the third character string str3 illustrated in FIG. 17, is associated as a “phonetic reading” with the term “ [symbol] ” (“lecture”) of No. 001, and the term “ [symbol] ” (“support”) of [symbol] No. 003, in the term database 6B illustrated in FIG. 15. Therefore, the generation section 12B extracts, from the term database 6B, the term “ [symbol] ” (“lecture”) and the term “ [symbol] ” (“support”), for which input conversion from the character string str3a included in the third character string str3 is possible.

### (Step S333B)

The process of step S333B is performed in a case where a plurality of terms have been extracted in step S3321B. In step S333B, the generation section 12B selects one of the plurality of terms on the basis of priority. For example, the generation section 12B may select a term among the plurality of terms which has the highest priority. Note that in a case where only one term was extracted in step S332B, the generation section 12B selects that term. In the example illustrated in FIG. 15, selected from among “ [symbol] ” (“lecture”; priority: 3) of No. 001 and the term “ [symbol] ” (support; priority: 1) of No. 003, is the term “ [symbol] ” (“lecture”) of No. 001, which has the higher priority.

### (Step S334B)

In step S334B, the generation section 12B replaces at least part of the first character string with the term selected in step S333B. Specifically, the generation section 12B uses, as a modification location, a location in the first character string corresponding to the term extracted in step S333B. Then, the generation section 12B generates, as the second character string, a character string in which the modification location in the first character string has been replaced with the term selected in step S333B. In the example illustrated in FIG. 17, the generation section 12B generates, as a second character string str4, the character string “ [symbol] [symbol] ” (“I'd like info about the lecture”), in which the modification location str2a in the first character string str2 has been replaced with the term “ [symbol] ” (“lecture”).

### Specific Example of Evaluation Information Database 5B

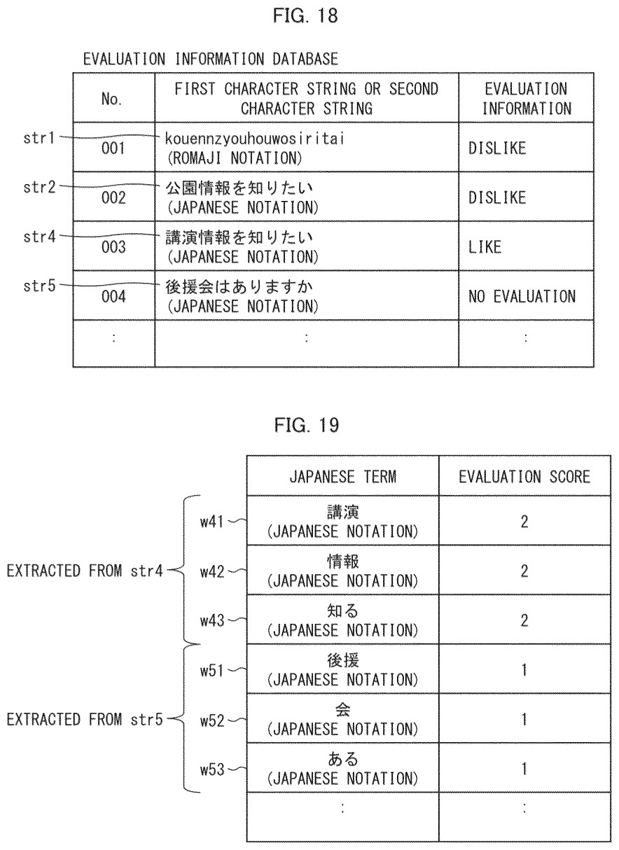

The following description will discuss a specific example of the evaluation information database 5B of the present example embodiment with reference to FIG. 18.

FIG. 18 is a diagram illustrating a specific example of the evaluation information database 5B of the present example embodiment. In the example illustrated in FIG. 18, the evaluation information “Dislike” of No. 1 is associated with the first character string str1. The evaluation information “Dislike” of No. 2 is associated with the first character string str2. The first character strings str1 and str2 are strings which have been input with an error in operation when attempting input of the actually intended character string str0, as described with reference to FIG. 17.

The response apparatus 2B would not be able to retrieve a text unit relating to the first character string str1 or str2, which each contain an error, when searching the text database 3B, and therefore would return a query result in which the search result has zero hits. The evaluation information of No. 001 and No. 002 indicates that the evaluation by a user with respect to these strings was bad.

The evaluation information “Like” of No. 003 is associated with the second character string str4. The second character string str4 has been generated by modifying the first character string str2, which contains an error, as described with reference to FIG. 17. The response apparatus 2B retrieves, from the text database 3B, the text units of No. 001 to No. 003, which relate to the second character string str4, and returns these text units as the query result. The evaluation information of No. 003 indicates that the evaluation by the user with respect to the query result was good.

Furthermore, the evaluation information “no evaluation” of No. 004 is associated with a first character string str5. The first character string str5 is a character string input by the user which is in Japanese notation and has the meaning “Is there a supporters' club?” The response apparatus 2B retrieves, from the text database 3B, the text unit of No. 004, which relates to the first character string str5, and returns the text unit as the query result. The evaluation information of No. 004 indicates that an evaluation by the user was not obtained with respect to this text unit.

### Specific Example of Update Process (Step S35)

The following description will discuss a specific example of the update process of step S35 in the present example embodiment with reference to FIG. 19. FIG. 19 is a diagram illustrating a specific example of an update process in the present example embodiment.

The update section 14B extracts a term from the first character string or the second character string (step S353 in FIG. 11). As a specific example, the update section 14B extracts three terms from the second character string str4 illustrated in FIG. 18, namely, a term w41 (having the meaning “lecture”), a term w42 (having the meaning “information”), and a term w43 (having the meaning “know”), which are in kanji notation. Then, the update section 14B extracts three terms from the first character string str5 illustrated in FIG. 18, namely, a term w51 (having the meaning “support”) and a term w52 (having the meaning “club”), which are in kanji notation, and a term w53 (having the meaning “is”). Assumed here is a case where the terms w41 to w43 and w51 to w53 that have been extracted all satisfy a condition (step S354 in FIG. 11).

As illustrated in FIG. 19, for each of the terms w41 to w43 which have been extracted from the second character string str4, the update section 14B determines an evaluation score of “2”, which is in accordance with the evaluation information “Like” associated with the second character string str4. Furthermore, because the term w41 corresponds to the term of No. 001 illustrated in FIG. 15, the update section 14B updates the priority thereof to “5”, by adding the evaluation score of “2” to the pre-update priority of “3” of that term. Furthermore, for example, in a case where the evaluation score of the term w41 is thereafter increased by “2” via a further update of the evaluation information database 5B, the update section 14B updates the priority to “7”, by adding the evaluation score increase of “2” to the priority “5” of the term which was previously updated.

Furthermore, as illustrated in FIG. 19, for each of the terms w51 to w53 which have been extracted from the first character string str5, the update section 14B determines an evaluation score of “1”, which is in accordance with the evaluation information “no evaluation” associated with the second character string str5. Because the term w51 corresponds to the term of No. 003 illustrated in FIG. 15, the update section 14B updates the priority thereof to “2”, by adding the evaluation score of “1” to the pre-update priority of “1” of that term. For the other terms w42, w43, w52, and w53 which were extracted, the update section 14B similarly updates the respective priorities thereof on the basis of the evaluation score.

### Example Advantages of Present Example Embodiment

The present example embodiment employs a configuration in which (i) the first character string is input into the response apparatus 2B with use of an input language involving input conversion, (ii) the identification section 15B identifies, with respect to the first character string, a third character string that is a character string prior to input conversion, and (iii) the generation section 12B extracts, from the term database 6B, a term for which input conversion from at least part of the third character string is possible, and replaces the at least part of the first character string with the term thusly extracted.

Note here that an input language involving input conversion requires various operations for input conversion, and thus there is the possibility that the user will perform an operation that differs from what is actually intended. According to the above configuration, at least part of the third character string, which is character string prior to input conversion by the user, is re-converted into a term from the term database 6B to generate the second character string. Therefore, even in a case where the user performed an operation that differs from what is actually intended, it is possible to generate a more suitable second character string for obtaining a query result. As a result, it is possible to improve the accuracy of a response by the response apparatus 2B in a case where a query is input with use of an input language involving input conversion.

### Variation

In the second and third example embodiments described above, step S33 illustrated in FIG. 8 can be altered as follows.

In step S33, the generation section 12A or 12B may generate a plurality of candidates which can become the second character string and select one of the plurality of candidates as the second character string on the basis of an operation by the user. For example, in step S332 of FIG. 10, or in step S333B of FIG. 16, the generation section 12A or 12B selects, on the basis of priority, a plurality of terms from among a plurality of terms extracted from the term database 6A or 6B. For example, the plurality of terms that are selected may be a prescribed number of terms (two or more) starting in order from the term with the highest priority, or may be terms that have a priority greater than or equal to a threshold value. Furthermore, in step S333 of FIG. 10, or in step S334B of FIG. 16, the generation section 12A or 12B generates candidates for the second character string, in which a modification location in the first character string is replaced with a respective term from among the plurality of terms that have been selected. The generation section 12A or 12B then presents the plurality of candidates to the user by sending the plurality of candidates to the response apparatus 2A or 2B. Then, the generation section 12A or 12B can select, as the second character string, one of the plurality of candidates on the basis of an operation by the user with respect to the response apparatus 2A or 2B.

### Example Advantage of the Present Variation

In the present variation, the generation section 12A or 12B generates a plurality of candidates which can become the second character string and selects one of the plurality of candidates as the second character string on the basis of an operation by the user. According to the above configuration, it is possible to modify the first character string and generate a second character string that is suited to the intent of the user, and it is possible to improve the satisfaction of the user with respect to the response from the response apparatus 2A or 2B.

### Other Variations

In the second and third example embodiments described above, in a case where the amount of information included in the search result for the first character string is less than or equal to a threshold value, the response apparatus 2A or 2B may skip outputting a query result therefor, and output a query result for the second character string. In this case, the information processing apparatus 1A or 1B acquires evaluation information in accordance with the second character string, without acquiring evaluation information in accordance with the first character string.

Furthermore, in the second and third example embodiments described above, the response apparatus 2A or 2B may be provided with at least a portion of functional blocks provided to the information processing apparatus 1A or 1B, and may perform at least a portion of the processes performed by the information processing apparatus 1A or 1B. Furthermore, the information processing apparatus 1A or 1B may be provided with at least a portion of functional blocks provided to the response apparatus 2A or 2B, and may perform at least a portion of the processes performed by the information processing apparatus 1A or 1B.

Furthermore, discussed in the third example embodiment was an example case in which the language involving input conversion was Japanese, but similar example advantages are brought about even in cases of application to languages other than Japanese that involve input conversion.

### Software Implementation Example

Some or all of functions of the information processing apparatuses 1, 1A, and 1B can be realized by hardware such as an integrated circuit (IC chip) or the like or can be alternatively realized by software.

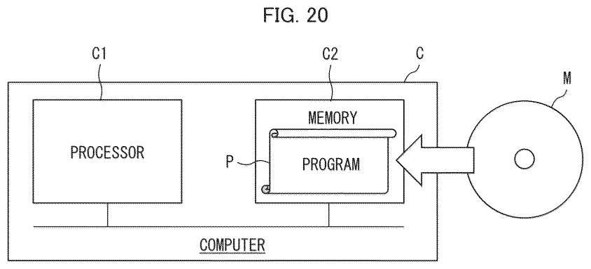

In the latter case, each of the information processing apparatuses 1, 1A, and 1B is realized by, for example, a computer that executes instructions of a program that is software realizing the foregoing functions. FIG. 20 illustrates an example of such a computer (hereinafter referred to as “computer C”). The computer C includes at least one processor C1 and at least one memory C2. The memory C2 stores a program P for causing the computer C to operate as the information processing apparatuses 1, 1A, and 11B. In the computer C, the processor C1 reads and executes the program P stored in the memory C2, so that the functions of the information processing apparatuses 1, 1A, and 1B are realized.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 may be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. In addition, the computer C may further include a communication interface via which the computer C transmits/receives data to/from another apparatus. The computer C may further include an input/output interface for connecting the computer C to an input/output apparatus(es) such as a keyboard, a mouse, a display, and/or a printer.

The program P can also be recorded in a non-transitory tangible storage medium M from which the computer C can read the program P. Examples of the storage medium M encompass a tape, a disk, a card, a semiconductor memory, and a programmable logic circuit. The computer C can obtain the program P via the storage medium M. Further, the program P can be transmitted via a transmission medium. Examples of the transmission medium encompass a communication network or a broadcast wave. The computer C can also obtain the program P via the transmission medium.

### [Supplementary Note 1]

The present invention is not limited to the example embodiments, but can be altered by a skilled person in the art within the scope of the claims. For example, the present invention also encompasses, in its technical scope, any embodiment derived by combining technical means disclosed in differing example embodiments.

### [Supplementary Note 2]

Some or all of the above example embodiments can be described as below. Note, however, that the present invention is not limited to aspects described below.

### (Supplementary Note 1)

An information processing apparatus including:
an input acquisition means that acquires a first character string indicating a query from a user;
a generation means that refers to a term database and generates a second character string which is obtained by replacing at least part of the first character string with a term from the term database;
an evaluation acquisition means that acquires evaluation information which indicates an evaluation by the user with respect to a query result in response to a query indicated by the first character string or by the second character string; and
an update means that updates the term database on the basis of the evaluation information.

According to the above configuration, the term database, which is used for replacing at least part of the query from the user, is updated on the basis of the evaluation by the user with respect to the query result. Using a term database updated in this way makes it possible to more accurately modify a query from a user. As a result, it is possible to accurately modify a query from a user and increase the accuracy of a response thereto.

### (Supplementary Note 2)

The information processing apparatus according to supplementary note 1, in which:
the query result indicates a search result obtained by using the first character string or the second character string to perform a search with respect to a plurality of text units relating to a specific field; and
the term database includes some or all from among (i) terms that are included in the plurality of text units, (ii) a set of synonyms which relate to the specific field, and (iii) a term that is included in the first character string or in the second character string.

According to the above configuration, the terms included in the plurality of text units are suitable for a query with respect to the text units. Furthermore, the set of synonyms relating to the specific field are suitable for a query with respect to the specific field. Further, the first character string input by the user or the second character string obtained by modifying the first character string may contain a term that suitably reflects an intent of the query by the user. Furthermore, these terms are updated on the basis of evaluation information from the user, and are therefore more suitable for a query with respect to the specific field. Therefore, according to the above configuration, it is possible to modify a query from the user into a character string suitable for a query relating to the specific field. As a result, there is an increased likelihood that it will be possible to retrieve, from the plurality of text units, a suitable text unit in accordance with the query, and it is possible to improve the accuracy of a response.

### (Supplementary Note 3)

The information processing apparatus according to supplementary note 1 or 2, in which:
the term database includes a plurality of terms and a priority of each of said terms;
the generation means replaces at least part of the first character string with a term that has been selected on the basis of the priority from among the plurality of terms in the term database; and
the update means updates the priority of each of the terms in the term database on the basis of the evaluation information.

According to the above configuration, a suitable term selected (i) in accordance with an evaluation by the user with respect to the query result and (ii) from among terms included in the first character string input by the user or a second character string obtained by modifying the first character string is used when generating a second character string. As a result, it is possible to improve the accuracy of a response.

### (Supplementary Note 4)

The information processing apparatus according to supplementary note 3, in which:
the update means
gives, to the each of the terms in the term database, a weight coefficient that is larger to smaller for the following cases in the following order: an evaluation indicated by the evaluation information being good; no evaluation information being obtained; and an evaluation indicated by the evaluation information being bad, and
updates the priority of each of the terms in the term database on the basis of the weight coefficient.

According to the above configuration, in a case where there is a good evaluation by the user with respect to a query result in response to the first character string input by the user or a second character string obtained by modifying the first character string, priority is updated with importance given to a term included in the first character string or the second character string. As a result, it is possible to generate a second character string with higher accuracy.

Furthermore, according to the above configuration, in a case where an evaluation by the user is not obtained, priority can be updated, with the importance given to a term included in the first character string or the second character string being next highest after that for a case where the evaluation is good. This is because a case where an evaluation is not obtained is not necessarily limited to a bad evaluation by the user, and may include a good evaluation. Therefore, there is the possibility that the first character string or the second character string includes a term that should be considered important.

Furthermore, according to the above configuration, in a case where there is a bad evaluation by the user, priority can be updated so that a term included in the first character string or the second character string is not considered important. This is because, in the case of a bad evaluation, there is a high likelihood that the content of the query from the user is, to begin with, not of the specific field for queries.

### (Supplementary Note 5)

The information processing apparatus according to any one of supplementary notes 1 to 4, in which
the generation means generates the second character string in a case where an amount of information included in the query result in response to the query indicated by the first character string is less than or equal to a threshold value.

According to the above configuration, in a case where the amount of information (number of text units) included in the query result in response to the first character string is less than or equal to a threshold value, presumably user satisfaction will be low. Therefore, the second character string is generated in such a case, and it is therefore possible to return a query result again with use of the second character string that has been generated, and it is possible to improve user satisfaction.

### (Supplementary Note 6)

The information processing apparatus according to any one of supplementary notes 1 to 5, in which
the generation means generates the second character string in a case where evaluation information with respect to the query result in response to the query indicated by the first character string satisfies a predetermined condition.

According to the above configuration, the second character string is generated in such a case. Therefore, it is possible to return a query result again with use of the second character string that has been generated, and it is possible to improve user satisfaction.

### (Supplementary Note 7)

The information processing apparatus according to any one of supplementary notes 1 to 6, in which:
the first character string is input by the user with use of an input language involving input conversion;
the information processing apparatus further includes an identification means that identifies, with respect to the first character string, a third character string that is a character string prior to input conversion; and
the generation means extracts, from the term database, a term for which input conversion from at least part of the third character string is possible, and replaces the at least part of the first character string with the term that has been extracted.

According to the above configuration, at least part of the third character string, which is character string prior to input conversion by the user, is converted into a term from the term database to generate the second character string. Therefore, even in a case where the user performed an operation that differs from what is actually intended, it is possible to generate a more suitable second character string for obtaining a query result. As a result, it is possible to improve the accuracy of a response in a case where a query has been input with use of an input language involving input conversion.

### (Supplementary Note 8)

The information processing apparatus according to any one of supplementary notes 1 to 7, in which
the generation means generates a plurality of candidates which can become the second character string and selects one of the plurality of candidates as the second character string on the basis of an operation by the user.

According to the above configuration, it is possible to modify the first character string and generate a second character string that is suited to the intent of the user, and it is possible to improve the satisfaction of the user with respect to the query result.

### (Supplementary Note 9)

An information processing system including:
an input acquisition means that acquires a first character string indicating a query from a user;
a generation means that refers to a term database and generates a second character string which is obtained by replacing at least part of the first character string with a term from the term database;
an evaluation acquisition means that acquires evaluation information which indicates an evaluation by the user with respect to a query result in response to a query indicated by the first character string or by the second character string; and
an update means that updates the term database on the basis of the evaluation information.

According to the above configuration, an effect similar to that brought about by Supplementary note 1 is brought about.

### (Supplementary Note 10)

An information processing method including:
acquiring a first character string indicating a query from a user;
referring to a term database and generating a second character string which is obtained by replacing at least part of the first character string with a term from the term database;
acquiring evaluation information which indicates an evaluation by the user with respect to a query result in response to a query indicated by the first character string or by the second character string; and
updating the term database on the basis of the evaluation information.

According to the above configuration, an effect similar to that brought about by Supplementary note 1 is brought about.

### (Supplementary Note 11)

A program for causing a computer to function as an information processing apparatus, the program causing the computer to function as:
an input acquisition means that acquires a first character string indicating a query from a user;
a generation means that refers to a term database and generates a second character string which is obtained by replacing at least part of the first character string with a term from the term database;
an evaluation acquisition means that acquires evaluation information which indicates an evaluation by the user with respect to a query result in response to a query indicated by the first character string or by the second character string; and
an update means that updates the term database on the basis of the evaluation information.

According to the above configuration, an effect similar to that brought about by Supplementary note 1 is brought about.

### [Supplementary Note 3]

Further, some or all of the above example embodiments can be expressed as below.

An information processing apparatus including at least one processor,
said processor performing:
an input acquisition process for acquiring a first character string indicating a query from a user;
a generation process for referring to a term database and generating a second character string which is obtained by replacing at least part of the first character string with a term from the term database;
an evaluation acquisition process for acquiring evaluation information which indicates an evaluation by the user with respect to a query result in response to a query indicated by the first character string or by the second character string; and
an update process for updating the term database on the basis of the evaluation information.

Note that this information processing apparatus may further include a memory, and, in this memory, a program may be stored which is for causing the at least one processor to carry out the . . . process, the . . . process, and the . . . process. The program may be stored in a non-transitory, tangible storage medium capable of being read by a computer.

### REFERENCE SIGNS LIST

1, 1A, 1B Information processing apparatus
2A, 2B Response apparatus
3A, 3B Text database
4A, 4B Synonym database
5A, 5B Evaluation information database
6A, 6B Term database
7A, 7B Management apparatus
10, 10A, 10B Information processing system
11, 11A, 111B Input acquisition section
12, 12A, 12B Generation section
13, 13A, 13B Evaluation acquisition section
14, 14A, 14B Update section
15B Identification section
C1 Processor
C2 Memory

What is claimed is:

1. An information processing apparatus comprising
at least one processor,
the at least one processor performing:
an input acquisition process for acquiring a first character string indicating a query from a user;
a generation process for referring to a term database and generating a second character string which is obtained by replacing at least part of the first character string with a term from the term database;
an evaluation acquisition process for acquiring evaluation information which indicates an evaluation by the user with respect to a query result in response to a query indicated by the first character string or by the second character string; and
an update process for updating the term database on the basis of the evaluation information.

2. The information processing apparatus according to claim 1, wherein:
the query result indicates a search result obtained by using the first character string or the second character string to perform a search with respect to a plurality of text units relating to a specific field; and
the term database includes some or all from among (i) terms that are included in the plurality of text units, (ii) a set of synonyms which relate to the specific field, and (iii) a term that is included in the first character string or in the second character string.

3. The information processing apparatus according to claim 1, wherein:
the term database includes a plurality of terms and a priority of each of said terms;
in the generation process, the at least one processor replaces at least part of the first character string with a term that has been selected on the basis of the priority from among the plurality of terms in the term database; and
in the update process, the at least one processor updates the priority of each of the terms in the term database on the basis of the evaluation information.

4. The information processing apparatus according to claim 3, wherein:
in the update process, the at least one processor
gives, to the each of the terms in the term database, a weight coefficient that is larger to smaller for the following cases in the following order: an evaluation indicated by the evaluation information being good; no evaluation information being obtained; and an evaluation indicated by the evaluation information being bad, and
updates the priority of each of the terms in the term database on the basis of the weight coefficient.

5. The information processing apparatus according to claim 1, wherein
in the generation process, the at least one processor generates the second character string in a case where an amount of information included in the query result in response to the query indicated by the first character string is less than or equal to a threshold value.

6. The information processing apparatus according to claim 1, wherein
in the generation process, the at least one processor generates the second character string in a case where evaluation information with respect to the query result in response to the query indicated by the first character string satisfies a predetermined condition.

7. The information processing apparatus according to claim 1, wherein:
the first character string is input by the user with use of an input language involving input conversion;
the at least one processor further performs an identification process for identifying, with respect to the first character string, a third character string that is a character string prior to input conversion; and
in the generation process, the at least one processor extracts, from the term database, a term for which input conversion from at least part of the third character string is possible, and replaces the at least part of the first character string with the term that has been extracted.

8. The information processing apparatus according to claim 1, wherein
in the generation process, the at least one processor generates a plurality of candidates which can become the second character string and selects one of the plurality of candidates as the second character string on the basis of an operation by the user.

9. An information processing system comprising
at least one processor,
the at least one processor performing:
an input acquisition process for acquiring a first character string indicating a query from a user;
a generation process for referring to a term database and generating a second character string which is obtained by replacing at least part of the first character string with a term from the term database;
an evaluation acquisition process for acquiring evaluation information which indicates an evaluation by the user with respect to a query result in response to a query indicated by the first character string or by the second character string; and
an update process for updating the term database on the basis of the evaluation information.

10. An information processing method comprising:
at least one processor acquiring a first character string indicating a query from a user;
the at least one processor referring to a term database and generating a second character string which is obtained by replacing at least part of the first character string with a term from the term database;
the at least one processor acquiring evaluation information which indicates an evaluation by the user with respect to a query result in response to a query indicated by the first character string or by the second character string; and
the at least one processor updating the term database on the basis of the evaluation information.

11. A non-transitory storage medium storing therein a program for causing a computer to function as the information processing apparatus according to claim 1, the program causing the computer to perform:
the input acquisition process;
the generation process;
the evaluation acquisition process; and
the update process
